(19) United States
(12) Patent Application Publication
(10) Pub. No.: US 2006/0153624 A1
(43) Pub. Date: Jul. 13, 2006

(54) Printer

(75) Inventors: Takashi Maeda, Daito-shi (JP); Masami Shiratori, Daito-shi (JP)

Correspondence Address: CROWELL & MORING LLP;INTELLECTUAL PROPERTY GROUP, P.O. BOX 14300, WASHINGTON, DC, 20044-4300, US

(73) Assignee: Funai Electric Co., Ltd., Daito-shi (JP)

(21) Appl. No.: 11/324,598

(22) Filed: Jan. 4, 2006

(30) Foreign Application Priority Data
Jan. 7, 2005 (JP) 2005-002017

(51) Int. Cl. B41J 15/16; B41J 15/04

(52) U.S. Cl. 400/636; 400/611; 400/611; 400/645

(57) ABSTRACT

A printer has a discharging roller, and a discharging section having first and second pinch rollers. The first pinch roller and the second pinch roller are arranged such that a mounting angle of the first pinch roller is smaller than a mounting angle of the second pinch roller, wherein the former angle is defined by an axis approximately vertical to the second conveying direction and a first segment passing through a rotary axis of the discharging roller and a rotary axis of the first pinch roller; and the latter angle is defined by the axis and a second segment passing through the rotary axis of the discharging roller and a rotary axis of the second pinch roller. With a recording paper pinched between these rollers, the recording paper is conveyed to a discharging-outlet while being subjected to correction for a curl of the recording paper. This enables the curl of the recording paper to be effectively corrected without failure of the conveyance of the recording paper in the discharging section.

### BACKGROUND OF THE INVENTION

1. Field of the Invention

The present invention relates to a printer and particularly to a recording medium conveying mechanism of a printer.

2. Description of the Related Art

Conventionally, there has been known a printer with a discharging section that conveys a recording paper to a discharging-outlet, as shown in FIG. 3. This printer has a toner transferring section that forms an image on a recording paper (P) by transferring toner onto the recording paper; a fixing section that fixes the image formed on the recording paper by heating the recording paper conveyed from the toner transferring section; and a conveying path through which the recording paper passed through the fixing section is guided to the discharging section, or the like. Usually, the conveying path of this printer includes a path on which the conveying direction of a recording paper in the fixing section is changed to the conveying direction of the recording paper in the discharging section. On the conveying path, the recording paper is changed in its conveying direction and guided to the discharging section. In the discharging section, the recording paper is conveyed to the discharging-outlet with it pinched between a discharging roller 131 that is rotatably driven by a motor, and a pinch roller 134 following the discharging roller 131. At this time, in order for the discharging section to correct the curl of the recording paper occurred when it is conveyed through the conveying path, the curled recording paper is conveyed with it curved in the opposite direction to the curl direction.

A degree that a recording paper will curl during the time it is conveyed depends on the constructions and arrangements of the fixing section and the conveying path, or the like. Depending on the type of a printer, an enhanced curl correcting function is required of the discharging section in some cases. For example, in such a printer that there is enough distance from a fixing section to a discharging section and hence a conveying direction is changed on a conveying path after a recording paper heated in the fixing section is cooled sufficiently, the recording paper is hard to curl. On the other hand, in such a printer that the distance from a fixing section to a discharging section is short and hence the conveying direction of a recording paper is changed when its temperature is relatively high, the recording paper is easy to curl because the conveying direction is changed at a high temperature. In the latter printer, a short distance from the fixing section to the discharging section is advantageous in realizing a compact printer, however, it is necessary to provide an enhanced curl correcting function to the discharging section.

As a method for improving the curl correcting function of the discharging section, it can be considered to increase a mounting angle γ between a first pinch roller 132 and a second pinch roller 133 with respect to the discharging roller 131. The mere increase in the mounting angle γ leads to an increase in an interposing angle θ′ of a recording paper with respect to the discharging roller 131 (θ′; an angle defined by a tangent C′ of the discharging roller 131 at a contact point B′ between the discharging roller 131 and the tip of the recording paper, and a conveying direction D of the recording paper P) θ′. This may cause failure to pinch the recording paper between the discharging roller 131 and the first pinch roller 132. There is thus the danger of hindering the conveyance of the recording paper.

As a printer adapted to achieve correction for a curl of a recording paper or the like, there are known, for example, a printer in which a driving roller and two pinch rollers following the driving roller are arranged at a stage before forming an image on a recording paper (see, for example, Japanese Laid-Open Patent. Publication No. 2004-155027); a printer adapted to correct a curl by causing a recording paper to curve in the opposite direction to the curl direction by vacuum-suction of the recording paper (see, for example, Japanese Laid-Open Patent Publication No. Sho-56-56452); and a printer in which a curl correcting function is added to a stripping member for use in separating a recording paper from a heating drum (see, for example, Japanese Laid-Open Patent Publication No. 2002-278036).

However, the printers described in the above three publications are intended to correct the curl by a construction other than the discharging section shown in FIG. 3, and these do not aim at improving the curl correcting function of the discharging section. Although the printer described in Japanese Laid-Open Patent Publication No. 2004-155027 has the driving roller and the two pinch rollers following the driving roller, it is not adapted to enable the curl correcting function to be improved without failure of conveyance of a recording paper.

### SUMMARY OF THE INVENTION

It is an object of the present invention to solve the above problem by providing a printer capable of effectively correcting a curl of a recording medium without hindering the conveyance of the recording medium in a discharging section.

According to one aspect of the present invention, there is provided a printer having: (i) a fixing section that fixes an image formed on a recording medium by heating the recording medium; (ii) a discharging section that is disposed on the downstream side in a recording medium conveying direction in the fixing section, and that coveys a recording medium to a discharging-outlet with the recording medium pinched between a discharging roller rotatably driven by a motor and a pinch roller following the discharging roller; and (iii) a conveying path through which a recording medium passed through the fixing section is guided to the discharging-outlet. The conveying path has a first path through which a recording medium is conveyed while the conveying direction of a recording medium passed through the fixing section is maintained in the recording medium conveying direction in the fixing section (hereinafter referred to as a “first conveying direction); and a second path on which the conveying direction of a recording medium is changed from the first conveying direction to a conveying direction in the discharging section (hereinafter referred to as a “second conveying direction”). The pinch roller of the discharging section has a first pinch roller disposed on the upstream side and a second pinch roller disposed on the downstream side. In order for the discharging section to correct a curl of a recording medium occurred when conveyed through the conveying path, the curled recording medium is conveyed with it curved in the reverse direction of the curl direction. The first pinch roller and the second pinch roller are arranged such that a mounting angle of the first pinch roller is smaller than a mounting angle of the second pinch roller, wherein the former angle is defined by an axis approximately vertical to the second conveying direction and a first segment passing through a rotary axis of the discharging roller and a rotary axis of the first pinch roller; and the latter angle is defined by the axis and a second segment passing through the rotary axis of the discharging roller and a rotary axis of the second pinch roller.

By arranging the first pinch roller and the second pinch roller as described above, a curl of a recording medium can be corrected without failure of conveyance of the recording medium in the discharging section.

According to another aspect of the present invention, there is provided a printer wherein, to decrease the length of the first conveying direction of the conveying path, the first path is held shorter than a conveying distance necessary for lowering the temperature of a recording medium heated in the fixing section to a temperature at which any curl is hard to occur.

With the purpose of decreasing the length of the first conveying direction (approximately a vertical direction), the first path is held shorter than the conveying distance necessary for lowering the temperature of a recording medium heated at the fixing section to a temperature at which any curl is hard to occur. This enables the height of a printer to be held low.

According to further aspect of the present invention, there is provided a printer wherein the first pinch roller and the second pinch roller are arranged such that the mounting angle of the second pinch roller is in a range of about 25 to 35 degrees.

By arranging the second pinch roller such that the mounting angle of the second pinch roller is not less than approximately 25 degrees, a recording paper can be curved sufficiently in the discharging section, allowing a curl of the recording paper to be corrected more effectively. On the other hand, by arranging the second pinch roller such that the mounting angle of the second pinch roller is not more than about 35 degrees, any pinch miss of a recording paper between the discharging roller and the second pinch roller, which may be caused by too large mounting angle of the second pinch roller, can be avoided to thereby prevent the conveyance of a recording paper from being failure in the discharging section.

### BRIEF DESCRIPTION OF THE DRAWINGS

FIG. 1 is a side view of a fixing section to a discharging section of a printer according to one preferred embodiment of the present invention;

FIG. 2 is a side view of the discharging section; and

FIG. 3 is a side view of the discharging section of a conventional printer.

### DESCRIPTION OF THE PREFERRED EMBODIMENTS

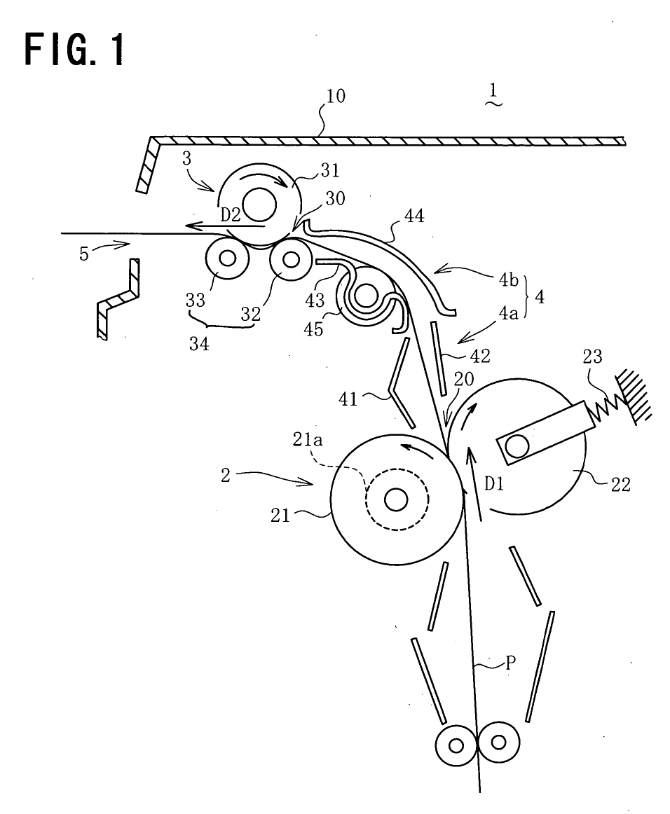

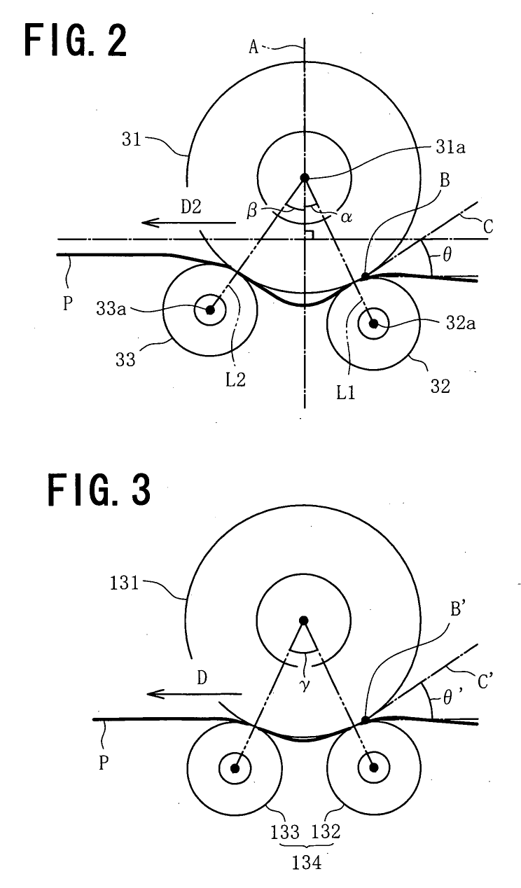

One preferred embodiment of the present invention will be described below with reference to FIGS. 1 and 2. A printer 1 is an apparatus that records an image on a recording medium, such as a recording paper P, based on image data (containing text data) inputted from a personal computer connected thereto, or the like. Disposed within a case 10 are: (i) a toner transferring section (not shown) that forms an image on a recording paper P by transferring toner on a recording paper P conveyed from a feeding tray (not shown); (ii) a fixing section 2 that fixes the image formed on the recording paper P by heating the recording paper P conveyed from the toner transferring section; (iii) a discharging section 3 that is disposed on the downstream side in a recording paper conveying direction in the fixing section 2, and that coveys the recording paper P to a discharging-outlet 5 with the recording paper P pinched between a discharging roller 31 rotatably driven by a motor (not shown) and a pinch roller 34 following the discharging roller 31; and (iv) a conveying path 4 through which the recording paper P passed through the fixing section 2 is guided to the discharging section 3.

The fixing section 2 has a heating roller 21 and a pressure roller 22 that are used in fixing and are oppositely disposed. The heating roller 21 has in its interior a heater 21a, and the heating roller 21 heats a recording paper P to a predetermined temperature (e.g., about 90° C.). The pressure roller 22 is made up of a rubber roll, for example, and is normally pressed into contact with the heating roller 21 at a predetermined pressure by a spring 23. In the fixing section 2, the heating roller 21 and the pressure roller 22 pinch a recording paper P and feed it in a first conveying direction D1 that is approximately a vertical direction. Thus, the image on a recording paper P can be fixed by the heat supplied from the heating roller 21 to the recording paper P, and the pressure applied by the pressure roller 22.

The conveying path 4 includes a first path 4a through which the recording paper P passed through the fixing section 2 is conveyed while the conveying direction of the recording paper P is maintained in the first conveying direction D1; and a second path 4b on which the conveying direction of the recording paper P is changed from the first conveying direction D1 to a second conveying direction D2 that is approximately a horizontal direction in the discharging section 3. The first path 4a has guide plates 41 and 42 to guide the recording paper P passed through the fixing section 2. The second path 4b has arcuate guide plates 43 and 44 to change the conveying direction of the recording paper P, and a driven roller 45 disposed in the middle of the arcuate guide plate 43.

In the printer 1 of this preferred embodiment, to decrease the length of the first conveying direction D1 of the conveying path 4, the first path 4a is shorter than a conveying distance necessary for lowering the temperature of a recording paper P heated at the fixing section 2 to a temperature at which any curl is hard to occur. As used herein, the expression “a conveying distance necessary for lowering the temperature of a recording paper heated at the fixing section to a temperature at which any curl is hard to occur” means the maximum distance from an outlet 20 of the fixing section 2, through which the temperature of the recording paper P approaches the temperature of the recording paper P in the fixing section 2 than the temperature of the air in the vicinity of an inlet 30 of the discharging section 3. Under such a high temperature, the change of the conveying direction of the recording paper P facilitates the occurrence of a curl on the recording paper P. In other words, when the conveying direction is changed before the recording paper P is cooled sufficiently (i.e., before the temperature of the recording paper P is sufficiently close to the peripheral air temperature), the recording paper P is easy to cause a curl. On the contrary, in accordance with this preferred embodiment, the conveying direction of the recording paper P is changed before it is cooled sufficiently, and the correction for a curl is accomplished by the discharging section 3, the curl correcting function of which is enhanced.

The discharging section 3 will next be described with reference to FIG. 2. The pinch roller 34 of the discharging section 3 has a first pinch roller 32 disposed on the upstream side, and a second pinch roller 33 disposed on the downstream side. In order to correct a curl of a recording paper P which occurred when conveyed through the conveying path 4, the discharging section 3 conveys the curled recording paper P while causing it to curve in the opposite direction to the curl direction.

The first pinch roller 32 and the second pinch roller 33 are arranged such that a mounting angle α of the first pinch roller 32 is smaller than a mounting angle β of the second pinch roller 33, wherein the mounting angle α is defined by an axis A approximately vertical to the second conveying direction D2 and a first segment L1 passing through a rotary axis 31a of the discharging roller 31 and a rotary axis 32a of the first pinch roller 32; and the mounting angle β is defined by the axis A and a second segment L2 passing through the rotary axis 31a of the discharging roller 31 and a rotary axis 33a of the second pinch roller 33. Preferably, it is arranged such that the mounting angle β of the second pinch roller 33 is in a range of about 25 to 35 degrees. If the β is below about 25 degrees, a recording paper P cannot be curved sufficiently in the discharging section 3, and a strong curl to be caused by shortening the first path 4a cannot be corrected effectively in the discharging section 3. On the other hand, if the is above about 35 degrees, it may be difficult to pinch a recording paper β between the discharging roller 31 and the second pinch roller 33, so that there is danger of failure of conveyance of the recording paper P.

The flow of conveyance of a recording paper P in the printer 1 will next be described. The recording paper P passed through the toner transferring section is conveyed to the fixing section 2. The recording paper P is pinched between the heating roller 21 and the pressure roller 22, and then passed through the fixing section 2 while being heated there. The recording paper P passed through the fixing section 2 is guided by the guide plates 41 and 42 to pass through the first path 4a, and then conveyed at a relatively high temperature as mentioned above to the second path 4b. Through the second path 4b, the recording paper P is guided to the discharging section 3 by the arcuate guide plates 43 and 44 and the driven roller 45, while turning its conveying direction about 90 degrees. The recording paper P is cooled as it travels the conveying path 4. The recording paper P passed through the conveying path 4 is pinched between the discharging roller 31 and the pinch roller 34, and then discharged with its curl corrected, from the discharging-outlet 5.

Thus, in accordance with the printer 1 of this preferred embodiment, the first pinch roller 32 and the second pinch roller 33 are arranged such that the mounting angle α of the first pinch roller is smaller than the mounting angle β of the second pinch roller 33. With this arrangement, as shown in FIG. 2, the mounting angles of the first pinch roller 32 and the second pinch roller 33 (the angle expressed by the sum of the angle α and the angle β) with respect to the discharging roller 31 can be increased without increasing the interposing angle θ of the recording paper P (the angle defined by a tangent C of the discharging roller 31 at a contact point B to which the tip of the recording paper P contacts, and the second conveying direction D2 of the recording paper P) θ with respect to the discharging roller 31. It is therefore possible to effectively correct a curl of the recording paper P without failure of conveyance of the recording paper P in the discharging section 3.

Additionally, by arranging the second pinch roller 33 such that the mounting angle β of the second pinch roller 33 is not less than about 25 degrees, a recording paper P can be curved sufficiently in the discharging section 3 to thereby achieve more effective correction for a curl of the recording paper P. On the other hand, by arranging the second pinch roller 33 such that the mounting angle β of the second pinch roller 33 is not more than about 35 degrees, it is capable of preventing any pinch miss of a recording paper P between the discharging roller 31 and the second pinch roller 33, which may be caused by too large mounting angle β of the second pinch roller 33. This prevents the conveyance of a recording paper from being failure in the discharging section 3.

Additionally, in order to decrease the length of the first conveying direction (approximately a vertical direction) D1 of the conveying path 4, the first path 4a is held shorter than the conveying distance necessary for lowering the temperature of a recording paper P heated at the fixing section 2 to a temperature at which any curl is hard to occur. This enables the height of the printer 1 to be held low.

It is to be understood that the present invention should not be limited to the construction of the foregoing preferred embodiment but is susceptible of various changes and modifications. For example, the first conveying direction D1 may not be approximately a vertical direction, and the second conveying direction D2 may not be approximately a horizontal direction.

What is claimed is:

1. A printer comprising:
a fixing section that fixes an image formed on a recording medium by heating the recording medium;
a discharging section that is disposed on the downstream side in a recording medium conveying direction in the fixing section, and that coveys a recording medium to a discharging-outlet with the recording medium pinched between a discharging roller rotatably driven by a motor and a pinch roller following the discharging roller; and
a conveying path through which a recording medium passed through the fixing section is guided to the discharging-outlet;
wherein the conveying path having a first path through which a recording medium is conveyed while the conveying direction of a recording medium passed through the fixing section is maintained in the recording medium conveying direction in the fixing section (hereinafter referred to as a “first conveying direction); and a second path on which the conveying direction of a recording medium is changed from the first conveying direction to a conveying direction in the discharging section (hereinafter referred to as a “second conveying direction”);
the pinch roller of the discharging section having a first pinch roller disposed on the upstream side and a second pinch roller disposed on the downstream side, in order for the discharging section to correct a curl of a recording medium occurred when conveyed through the conveying path, the pinch roller conveying the curled recording medium with it curved in the reverse direction of the curl direction; and
the first pinch roller and the second pinch roller being arranged such that a mounting angle of the first pinch roller is smaller than a mounting angle of the second pinch roller, wherein the former angle is defined by an axis approximately vertical to the second conveying direction and a first segment passing through a rotary axis of the discharging roller and a rotary axis of the first pinch roller; and the latter angle is defined by the axis and a second segment passing through the rotary axis of the discharging roller and a rotary axis of the second pinch roller.

2. The printer according to claim 1, wherein, to decrease the length of the first conveying direction of the conveying path, the first path is held shorter than a conveying distance necessary for lowering the temperature of a recording medium heated in the fixing section to a temperature at which any curl is hard to occur.

3. The printer according to claim 1, wherein the first pinch roller and the second pinch roller are arranged such that the mounting angle of the second pinch roller is in a range of about 25 to 35 degrees.
